(19) United States
(12) Patent Application Publication
(10) Pub. No.: US 2010/0327031 A1
(43) Pub. Date: Dec. 30, 2010

(54) Car Clip and Magnetized Anchor for Portable Objects

(76) Inventor: Alejandro I. Olmos, Chula Vista, CA (US)

Correspondence Address: GEORGE S. LEVY, 3980 DEL MAR MEADOWS, SAN DIEGO, CA, 92130, US

(21) Appl. No.: 12/816,017

(22) Filed: Jun. 15, 2010

Related U.S. Application Data
(60) Provisional application No. 61/220,463, filed on Jun. 25, 2009.

(51) Int. Cl. A45F 5/00; F16M 13/02; B60R 11/00

(52) U.S. Cl. 224/269; 248/206.5; 224/545

(57) ABSTRACT

A supporting device for a portable object comprises an anchor having an anchoring end and a supporting end. The anchoring end is configured to be attachable to a grill, for example the grill of an automotive air conditioner. The supporting end is configured to carry two support implements. The first support implement operates by magnetic attraction and the second operates mechanically. The magnetic support implement is adapted to support a portable object if the object comprises magnetic material, and the mechanical support implement is adapted to support a portable object if the object does not comprise magnetic material.

This invention claims the benefit of U.S. Provisional Application No. 61/220,463 with the title, “Car Clip and Anchor for Bluetooth Earbud or Headset” filed on Jun. 25^{th} 2009 and which is hereby incorporated by reference. Applicant claims priority pursuant to 35 U.S.C. Par 119(e)(i). The present invention relates to magnetic holders and to clips. More particularly it relates to holders and clips used to hold objects in the grill of a car. These objects may include but are not restricted to, Bluetooth™ devices, earbuds, headsets, cell phones, GPS receivers, and eyeglasses.

### FIELD OF THE INVENTION

Patents PCT/US2007/079666 by Brown and WO2009/147514 by Zanetti are hereby incorporated by reference.

### BACKGROUND

The holding of mobile communication devices such as cell phones in a car is dangerous, and laws have been enacted in many states and countries against holding a cell phone while driving. Bluetooth earbuds or headsets circumvent the need for holding a cell phone and have become popular with motorists. These devices, however, can easily be misplaced or lost in a car. There is a need, therefore, for a means to hold or affix these devices to the interior of a car. This means should also be flexible enough to allow a user to reliably affix the Bluetooth device on one's body without the risk of losing it.

US Patent Application PCT/US2007/079666 by Brown describes a clip for a Bluetooth device, which can be affixed to the vent of a car. This device does not have the flexibility to be carried on a person, for example on a belt and to reliably hold a blue tooth device.

U.S. Pat. No. 7,099,467 by Walsh, and U.S. Pat. No. 7,099,467 by Rohrbach describe devices that can be inserted into the cup holder of a car, and which are designed to hold a portable electronic device such as a music player.

U.S. Pat. No. 6,491,194 by Marvin describes a sleeve like device for holding a cell phone, which can be mounted to the dashboard of a car by means of an adhesive strip or by hook and fastening strip.

U.S. Pat. No. 5,568,549 granted to Chin-Yang describes a flexible member which is equipped at one end with suction cups for attachment to a smooth surface inside a car such as the windshield, and at its other end with a sleeve for holding a cell phone.

U.S. Pat. No. 6,624,887 by Farmer describes a clip that holds an air freshening device, which can be mounted in a car air vent.

U.S. Pat. No. 7,292,823 by Kuo describes a Bluetooth headset in-car holder that can be plugged into the car cigarette lighter, thereby receiver power from the vehicle and that also embodies a speaker and a microphone to allow the user to communicate through the Bluetooth device without actually wearing it.

None of the prior art offers the utility value and the simplicity of this invention. Further features, aspects, and advantages of the present invention over the prior art will be more fully understood when considered with respect to the following detailed description claims and accompanying drawings.

### BRIEF DESCRIPTION OF THE DRAWINGS

FIG. 1 illustrates the invention as it uses its magnet to directly hold a headset or earbud comprising ferroelectric material.

FIG. 2 illustrates an addition to the invention designed to hold headsets or earbuds which are not comprised of ferroelectric material. The addition is a magnetized clip that mechanically holds the headset or earbud.

FIG. 3 shows the front end of the invention holding a non-magnetic headset or earbud.

FIG. 4 illustrates how a headset or earbud can be securely held inside the clip.

FIG. 5 shows how a headset or earbud can be accessibly held outside the clip.

FIG. 6 illustrates how the clip can be worn on a belt with the headset or earbud in a maximally accessible position.

FIG. 7 illustrates how the clip can be worn on a belt with the headset or earbud in a maximally secure position.

FIG. 8 shows how the anchor pin can be inserted into the grill covering an air conditioner or heater vent.

### SUMMARY OF THE INVENTION

The present invention is used to attach a portable device such as a cell phone a headset or an earbud to the grill covering the air conditioner or heater of a car. The device comprises at one end, an anchor approximately shaped as a spring loaded clothes pin and designed to fit into the grill, and at the other end, a supporting implement. This supporting implement has two modes of operation. The first is magnetic to support objects that contain magnets or ferromagnetic materials; the second supporting implement is mechanical to support non-magnetic objects.

The supporting end of the anchor is shaped like a fork. Switching between the magnetic and mechanical modes of operation is performed by a swivel mounted between the tines of the fork. The swivel carries a magnet. When the swivel has a particular orientation, the magnet is exposed thereby enabling the magnetic attachment mode. In the opposite orientation, the magnet is hidden inside the fork and the mechanical attachment implement is exposed, thereby enabling the mechanical attachment mode.

The mechanical attachment implement comprises a slot shaped in the body of the support end of the anchor, and a clip equipped with a disk-shaped protuberance configured to fit snugly inside the slot. The clip is used to hold non-magnetic objects. The clip can also carry a magnet or can be comprised of ferromagnetic material thereby allowing the user to choose if he wants to use the mechanical attachment method or the magnetic one. The clip can also be shaped like a key hole to hold objects having the shape of an hour-glass. The clip can also be shaped like a hook.

The sex of the clip and anchor can be reversed by placing the protuberance on the swivel and the slot on the clip. A retainer spring can be mounted inside the slot to allow a snappy attachment of the clip to the anchor.

The clip can also include a belt attachment to allow the user to carry portable objects on his belt.

Portable objects that can be supported by this invention include Bluetooth™ devices, earbuds, headsets, cell phones, GPS receivers, a short range radio communication link device, and eyeglasses.

### DETAILED DESCRIPTION

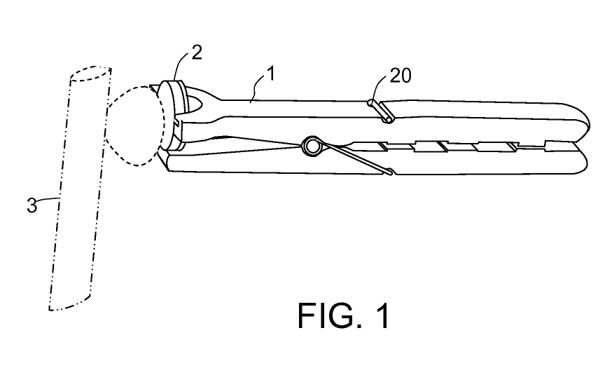

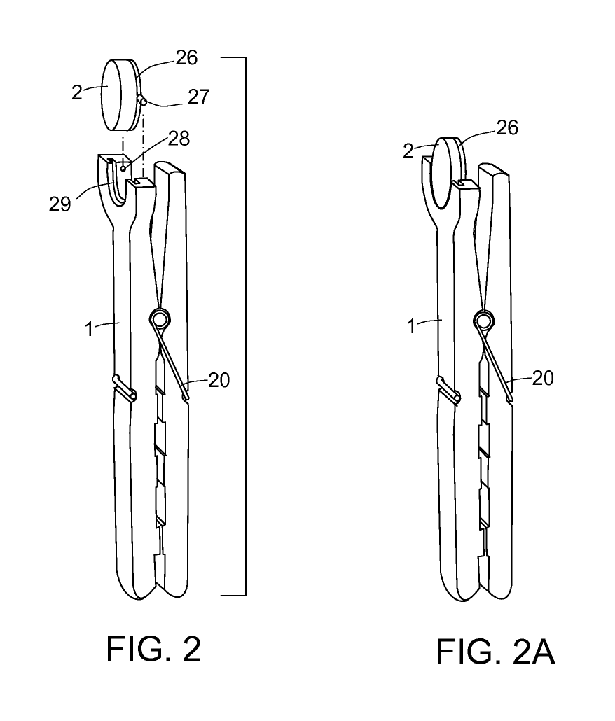

This invention is an anchor system for attaching portable objects to the grill covering the air-conditioner or heater vent of a car. Portable objects include Bluetooth™ devices, earbuds, headsets, cell phones, GPS receivers and pairs of eyeglasses. The invention is shown in FIGS. 1, 2 and 2A. Essentially it comprises an anchor 1 having its first end in the shape of a serrated fork, serrated pins or a clothes pin equipped with a spring 20 and adapted to fit inside the grill covering the vent for the air-conditioner or heater of the car.

The second end of the anchor 1 includes two attachment devices. The first attachment device is a magnet 2 mounted on a swivel. The second attachment device is a slot 29 configured in the body of the anchor 1.

The anchor 1 has two modes of operation. The first is a magnetic attachment mode to hold magnetic objects. The second is a mechanical attachment mode to hold non-magnetic objects. When operated in the magnetic attachment mode as shown in FIG. 1, the magnet 2 is swiveled to face outwards. A portable object 3 such as an earbud can be attached to the magnet 2 if the object contains ferromagnetic material or a magnet.

The swivel consists of a disk 26 onto which the magnet 2 is mounted. The disk 26 carries on its periphery two radial projections 27 that operate as axles and that fit into openings 28 configured in the second end of the anchor 1.

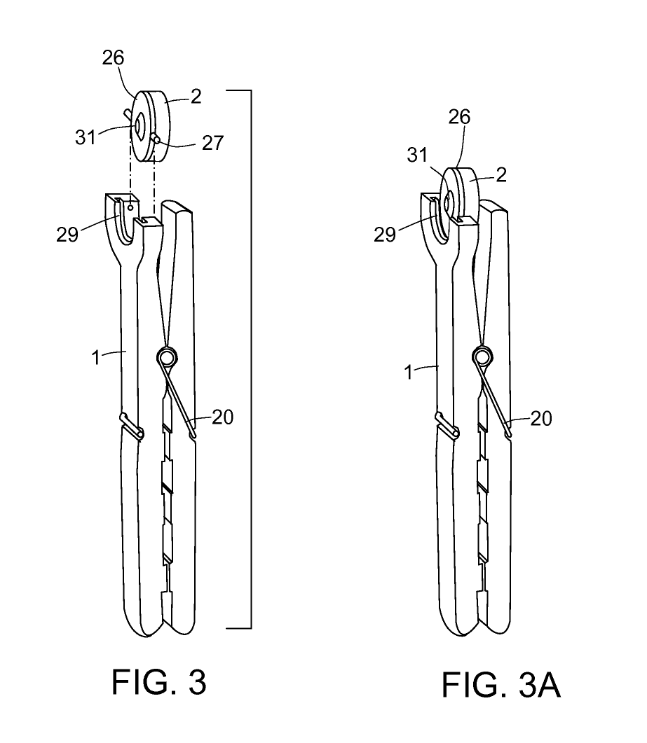

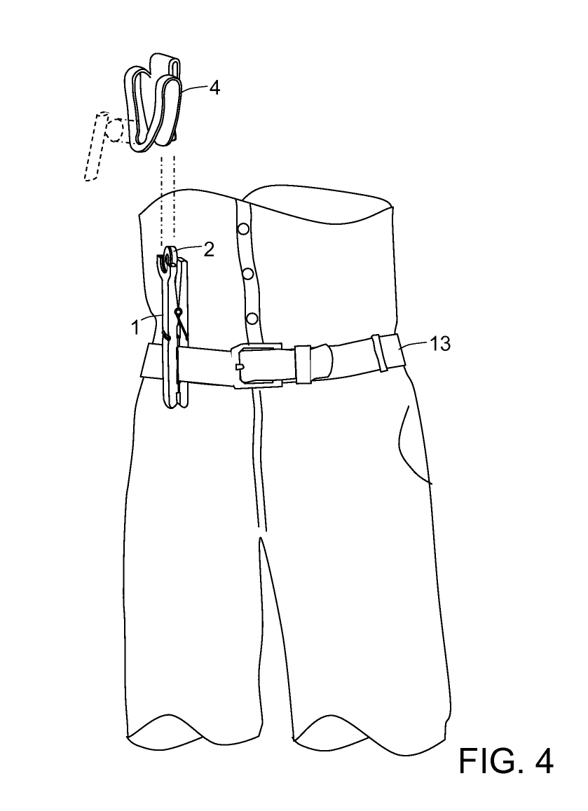

When operated in the mechanical attachment mode as shown in FIGS. 3, 3A and 4, the magnet 2 is swiveled to face inwards, thus exposing the slot 29. In this configuration, any object having a protuberance 30 that fits into the slot 29 can be mounted on the anchor 1. FIG. 4 illustrates how an anchor 1 mounted on a belt 13, can be used to hold a clip 4 with a slot fitting protuberance 30.

The swivel disk may be equipped with a small bump 31 to ensure that the fit of the protuberance 30 into the slot 29 is snug.

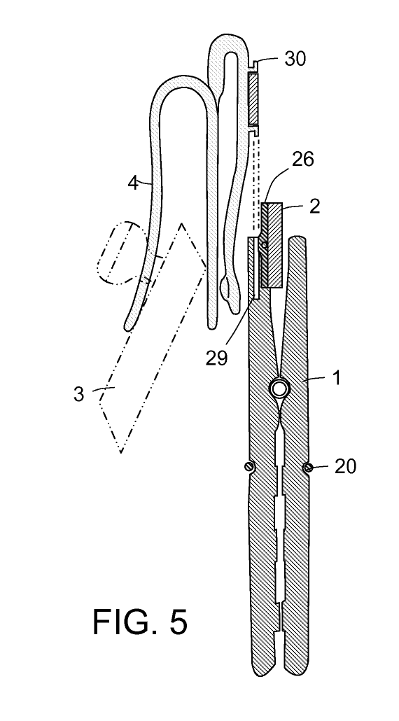

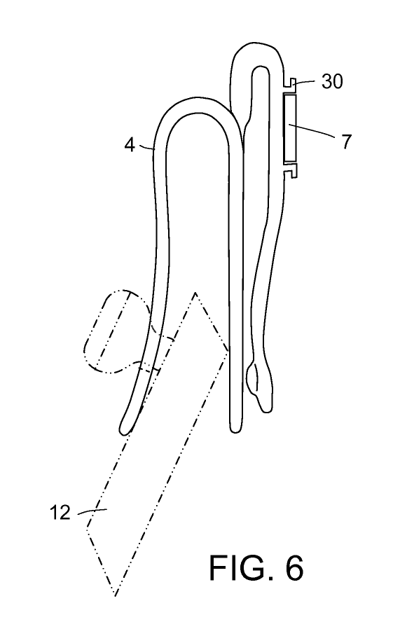

FIGS. 5 and 6 provide more details about the clip 4 equipped with the slot fitting protuberance 30. FIG. 5 is a cross section of the anchor 1 and the clip 4. FIG. 6 is a side view of the clip 4.

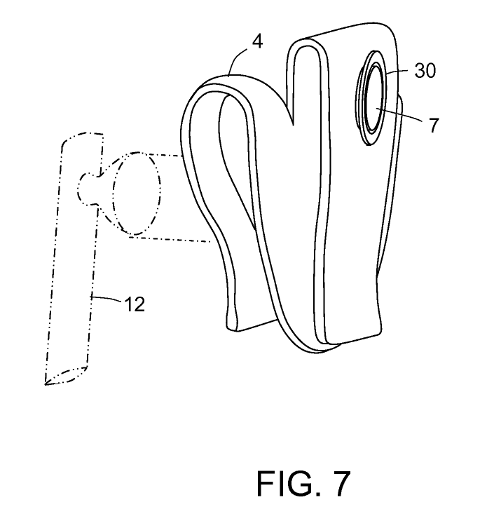

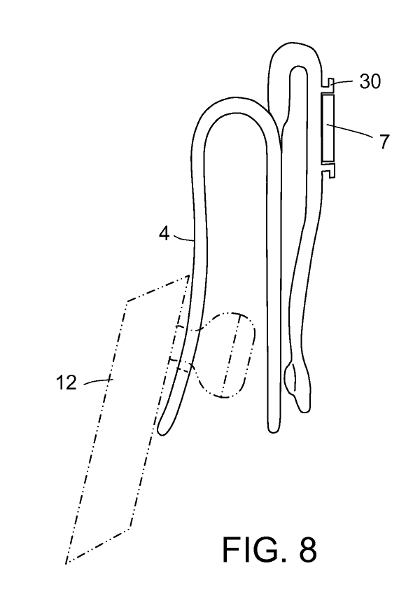

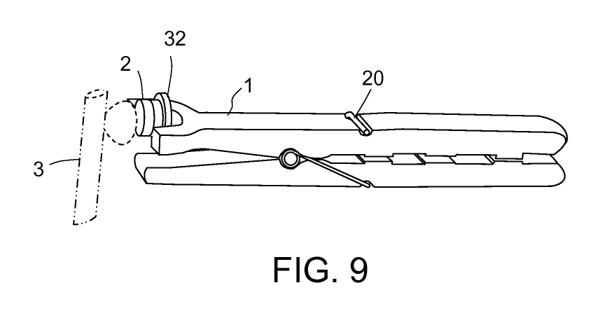

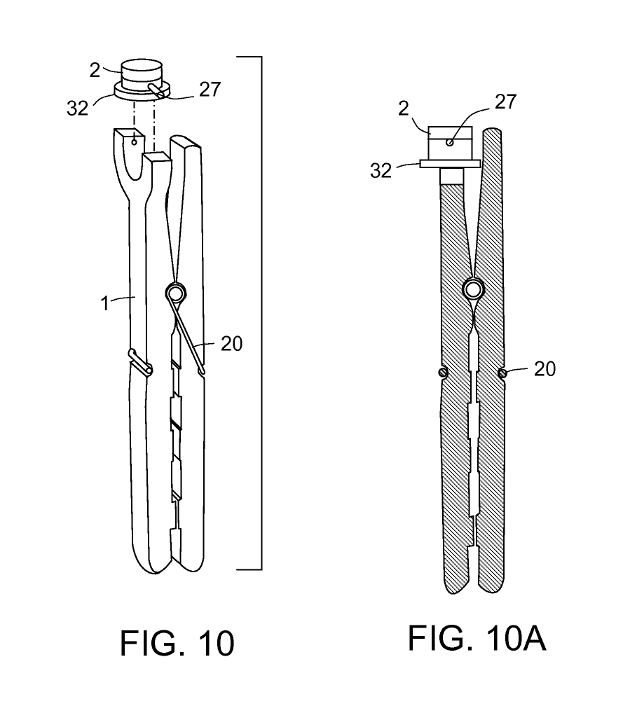

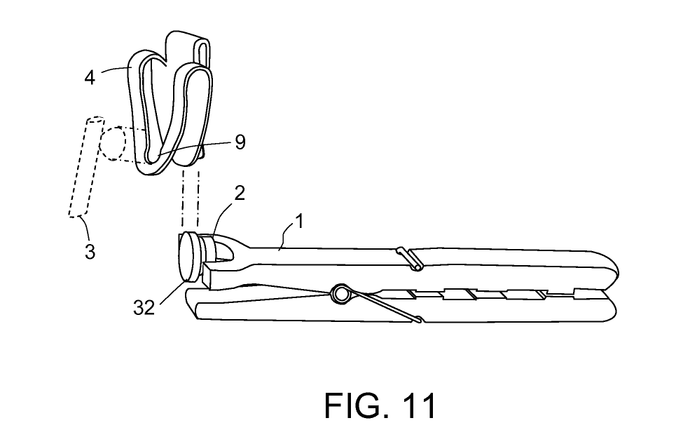

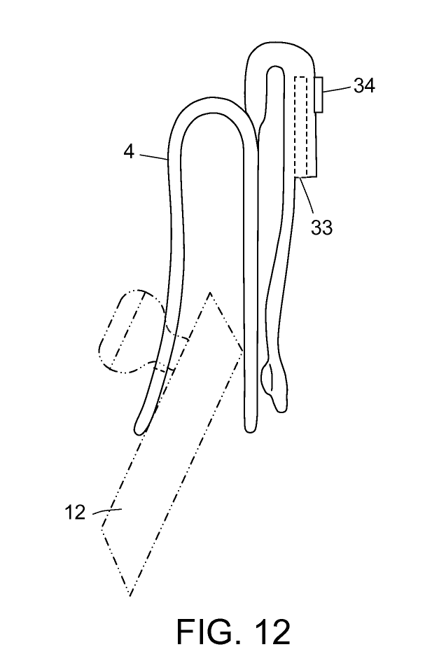

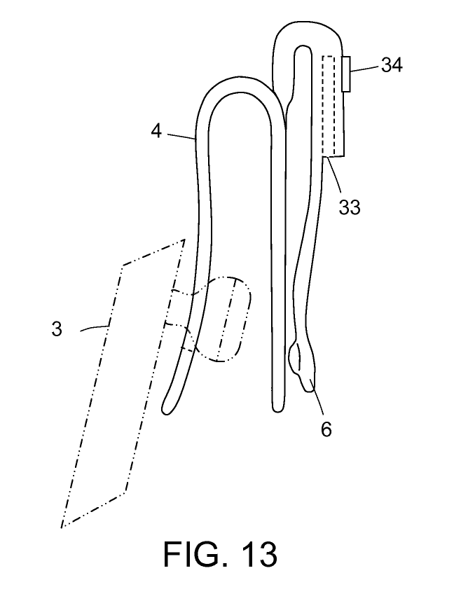

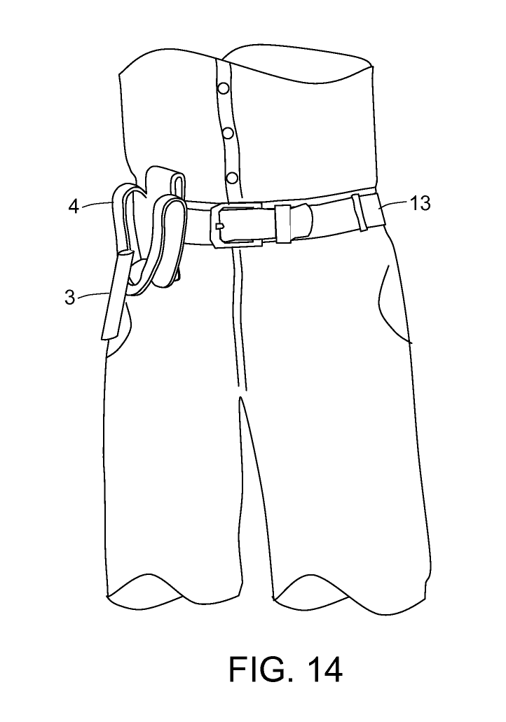

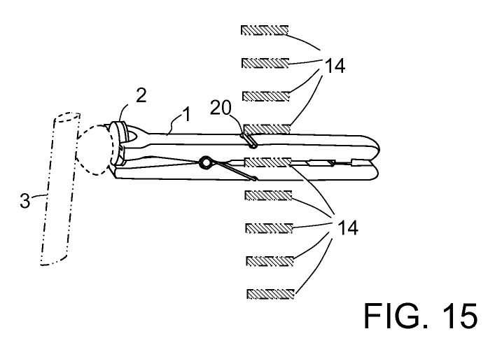

The clip 4 is comprised of springy material and is designed to hold a non-magnetic portable object 12 by pressure that it exerts on the object 12 as shown in FIGS. 5 and 6 or simply because it is configured as a hook as illustrated in FIGS. 7 and 8. FIG. 7 is a perspective view of the clip 4 and FIG. 8 shows the clip 4 operating as a hook and holding a non-magnetic earbud 12.

An alternative design shown in FIG. 9 reverses the sex of the anchor and clip. In this approach, the anchor 1 carries a swiveling magnet 2 attached to a disk 32 shaped to fit in the slot 33 configured inside the clip.

In the magnetic attachment mode shown in FIGS. 9, 10 and 10A the magnet 2 is swiveled outward and any object 3 carrying ferromagnetic material or a magnet can be attached to it. FIG. 9 illustrates the invention horizontally as it would fit into the grill of a car heater. FIG. 10 provides a perspective exploded view and FIG. 10A is a cross section view.

In the mechanical attachment mode shown in FIGS. 11 and 12, the magnet 2 is swiveled inwards thus exposing a protuberance 32 on the swivel. The clip 4 equipped with a slot 33 fitting the protuberance 32 can be attached to the anchor 1. A cross section of the clip 4 is shown in FIG. 12. It should be noted that the slot within the clip 4 can be fitted with a retaining spring to hold in place the protuberance 32, thereby maintaining a snappy and secure hold on the anchor.

The clip 4 may rely only on the mechanical attachment to the anchor. It may also, as an option, carry on its surface a magnetic material 34 to allow the user to quickly attach it or detach it from the magnet 2 on the anchor without having to use the mechanical attachment slot and protuberance means. This addition provides the user with the choice of attaching the clip 4 either magnetically or mechanically. Alternatively the clip 4, itself, could be made of ferromagnetic material thereby eliminating the need for the magnetic material 34.

The clip could hold an object either as shown in FIG. 12 by virtue of pressure applied by its springy material on the object, or simply, as shown in FIGS. 11 and 13, by hanging the object on the clip 4 using it as a hook. The front of the clip can be configured as a loop with a keyhole shape, having the smallest end at the bottom, thereby facilitating its utilization as a hook. As illustrated in FIG. 11, the retaining loop 9 is in a keyhole shape with the largest width on top to allow the user to easily insert his electronic device into it, and the smallest width at the bottom to hold the electronic device securely.

As shown in FIGS. 13 and 14 the rearward section 6 can also be shaped as a belt clip thereby allowing the user to wear it and carry the earbud or headset on his belt 13. The user can achieve a maximally accessible position for his electronic device by placing its body on the outside of the clip 4.

As shown in FIG. 15, the anchor 1 can be embedded into the grill 14 covering the AC or heater vent 14 of a car. As explained in this document, the anchor 1 can hold a Bluetooth device comprising ferroelectric material. It can also hold a clip carrying a magnet or ferroelectric material or a clip equipped with a mechanical attachment means compatible with the one on the anchor.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

I claim:

1. A supporting device for a portable object comprising:
a) an anchor having two ends,
i) first end being anchoring end, configured to be anchored into a grill;
ii) second end being supporting end, configured to carry two support implements, first said support implement operating by magnetic attraction, second support implement operating mechanically;
said magnetic support implement adapted to support said portable object if said portable object comprises magnetic material, and said mechanical support implement adapted to support said portable object if said portable object does not comprise magnetic material.

2. The supporting device of claim 1 also comprising a swiveling mechanism mounted on said supporting end, said swiveling mechanism carrying a magnet and configured to rotate in at least two orientations, first said orientation enabling the operation of said magnetic support implement and disabling the operation of said mechanical support implement, and second said orientation disabling the operation of said magnetic support implement and enabling the operation of said mechanical support implement.

3. The supporting device of claim 2 wherein said swivel comprises a disk carrying on its first side said magnet, said disk equipped on its periphery with two diametrically opposed and radially oriented axles, and furthermore, said supporting end of said anchor shaped as a two-tine fork, each tine equipped on the inside with a hole, said holes positioned to operate as bearings for said axles of said swivel.

4. The supporting device of claim 3 wherein said disk carries on its second side a bump configured to produce a snug fit in the operation of said mechanical support implement.

5. The supporting device of claim 3 wherein said fork has an inside located between said tines and an outside, and wherein in the first said orientation of said swivel said magnet is positioned outside of said fork thereby enabling the operation of said magnetic support implement, and furthermore, wherein in the second said orientation of said swivel said magnet is positioned inside said fork thereby disabling the operation of said magnetic support implement.

6. The supporting device of claim 1 wherein said mechanical support implement comprises:
a) a slot configured in said support end of said anchor;
b) a clip comprising a protuberance configured to fit removably inside said slot, said clip being used to hold said portable object.

7. The supporting device of claim 6 wherein said clip carries a magnet thereby allowing said clip to be magnetically attached to said anchor.

8. The supporting device of claim 6 wherein said clip comprises ferromagnetic material thereby allowing said clip to be magnetically attached to said anchor.

9. The supporting device of claim 6 wherein said clip comprises a loop having the shape of a keyhole thereby allowing objects that comprise an hour-glass shape to be removably attached to it.

10. The supporting device of claim 6 wherein said clip comprises a belt attachment means.

11. The supporting device of claim 2 wherein said mechanical support implement comprises:
a) a clip comprising a slot;
b) a protuberance configured in said swivel and configured to fit removably inside said slot;
said clip being used to hold said portable object.

12. The supporting device of claim 11 wherein said slot carries on its inside a retaining spring thereby allowing a snappy fit of said protuberance into said slot.

13. The supporting device of claim 11 wherein said clip carries a magnet thereby allowing said clip to be magnetically attached to said anchor.

14. The supporting device of claim 11 wherein said clip comprises ferromagnetic material thereby allowing said clip to be magnetically attached to said anchor.

15. The supporting device of claim 11 wherein said clip comprises a loop having the shape of a keyhole thereby allowing objects that comprise an hour-glass shape to be removably attached to it.

16. The supporting device of claim 11 wherein said clip comprises a belt attachment means.

17. The supporting device of claim 1 wherein said grill covers the vent for the air conditioner or the heater of a car.

18. The supporting device of claim 1 wherein said portable object is selected from the group consisting of Bluetooth™ devices, earbuds, headsets, cell phones, GPS receivers, short range radio communication link devices, and eyeglasses.

19. The magnetic holder of claim 1 wherein anchoring end of said supporting device is spring loaded and essentially in the shape of a clothes pin.

20. The magnetic holder of claim 1 wherein said mechanical support implement comprises a hook.
